(19) United States
(12) Patent Application Publication
(10) Pub. No.: US 2026/0190168 A1
(43) Pub. Date: Jul. 2, 2026

(54) COMMUNICATION APPARATUS, CONTROL METHOD THEREOF, AND STORAGE MEDIUM

(71) Applicant: CANON KABUSHIKI KAISHA, Tokyo (JP)

(72) Inventor: Chisei Sumita, Tokyo (JP)

(21) Appl. No.: 19/426,111

(22) Filed: Dec. 19, 2025

(30) Foreign Application Priority Data
Dec. 27, 2024 (JP) 2024-233117

(51) Int. Cl. H04W 76/15

(52) U.S. Cl. CPC H04W 76/15

(57) ABSTRACT

A communication apparatus comprises: at least one memory and at least one processor which function as: a connection unit configured to connect to a plurality of access points; a communication unit configured to transmit and receive data via the plurality of access points; and a display control unit configured to perform control such that a status of connection with each of a first number of access points included in the plurality of access points is displayed in a display unit using the first number of icons, the first number being two or more.

### BACKGROUND

### Field of the Technology

Techniques of the present disclosure relate to a communication apparatus capable of utilizing wireless communication compliant with IEEE 802.11, a control method thereof, and a storage medium.

### Description of the Related Art

With the increase in the amount of data communication in recent years, the development of communication technologies such as wireless Local Area Network (LAN) and the like is progressing. The IEEE 802.11 standard series is known as a major wireless LAN communication standard. The IEEE 802.11 standard series includes standards such as IEEE 802.11a/b/g/n/ac/ax/be.

Japanese Patent Laid-Open No. 2018-50133 discloses a communication apparatus compliant with IEEE 802.11a/b/g/n/ac/ax.

A system for multi-AP communication, in which multiple APs operate in cooperation with each other to transmit data to an STA, is also being considered.

Multi-AP communication has room for improvement in terms of the appropriateness of communication and usability.

### SUMMARY

Accordingly, the present disclosure provides a system for performing multi-AP communication more appropriately. Specifically, the present disclosure provides a system for more appropriately ascertaining the status of multi-AP communication.

To solve the above-described problem, according to one aspect of the present disclosure, a communication apparatus comprising: at least one memory and at least one processor which function as: a connection unit configured to connect to a plurality of access points; a communication unit configured to transmit and receive data via the plurality of access points; and a display control unit configured to perform control such that a status of connection with each of a first number of access points included in the plurality of access points is displayed in a display unit using the first number of icons, the first number being two or more is provided.

According to the foregoing configuration, the status of multi-AP communication can be ascertained more appropriately.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of the configuration of a wireless communication system.

FIG. 2A is a diagram illustrating the external appearance of an MFP 100.

FIG. 2B is a diagram illustrating an example of the configuration of the MFP 100.

FIG. 3A is a diagram illustrating an example of the display of a home screen in the MFP 100.

FIG. 3B is a diagram illustrating an example of the display of a menu screen for communication settings in the MFP 100.

FIG. 3C is a diagram illustrating an example of the display of a wireless LAN settings menu screen in the MFP 100.

FIG. 3D is a diagram illustrating an example of the display of a wireless LAN setup menu screen in the MFP 100.

FIG. 4A is a diagram illustrating the external appearance of a mobile terminal device 101.

FIG. 4B is a diagram illustrating an example of the configuration of the mobile terminal device 101.

FIG. 5 is an example of the configuration of an access point (AP).

FIG. 6 is a sequence chart illustrating processing involved in multi-AP communication, performed by an STA (the MFP 100) and an access point.

FIG. 7 is a diagram illustrating a display format of an icon according to a radio wave strength.

FIG. 8 is an example of the display of a communication status in the MFP 100.

FIG. 9 is a flowchart illustrating AP icon display processing performed by an MFP 100.

FIG. 10 is an example of the display of an AP icon in the MFP 100.

### DESCRIPTION OF THE EMBODIMENTS

An embodiment will be described in detail hereinafter with reference to the drawings. Note that the embodiment is merely an example, and the scope of the present disclosure is not intended to be limited to the specific examples of constituent elements, processing steps, display screens, and the like unless stated otherwise.

### System Configuration

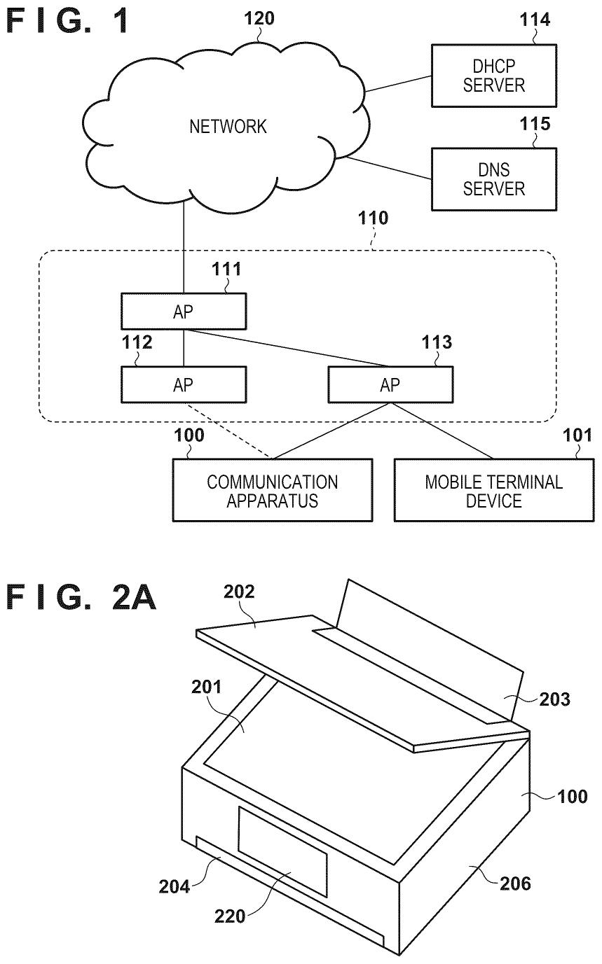

FIG. 1 illustrates an example of the configuration of a system according to the present embodiment. In one example, this system is a wireless communication system in which a plurality of communication apparatuses can communicate with each other wirelessly. The system illustrated in FIG. 1 includes an MFP 100 serving as a communication apparatus, a mobile terminal device 101, a multi-AP group 110 including a plurality of access points (APs), a DHCP server 114, a DNS server 115, and a network 120. Although the multi-AP group 110 will be described as including an AP 111, an AP 112, and an AP 113, the multi-AP group 110 may include more APs than these.

The mobile terminal device 101 is a device having a wireless communication function that uses wireless LAN or the like. “Wireless LAN” may be called “WLAN” hereinafter. The mobile terminal device 101 may be a personal information terminal such as a Personal Digital Assistant (PDA), a mobile telephone terminal (a smartphone), a tablet terminal, a digital camera, a personal computer, or the like.

The MFP 100 is a printing device having a printing function, and may further have a reading function (a scanner), a fax function, a telephone function, and the like. The MFP 100 according to the present embodiment also has a communication function that enables wireless communication with the mobile terminal device 101. Although the present embodiment describes a case where the MFP 100 is used as an example, the configuration is not limited thereto. For example, a scanner device, a projector, a mobile terminal, a smartphone, a laptop PC, a tablet terminal, a PDA, a digital camera, a music playback device, a television, a smart speaker, or the like, which has a communication function, may be used instead of the MFP 100. Note that “MFP” is an acronym for “Multi-Function Peripheral”.

The AP 111 is provided separate from (outside) the mobile terminal device 101 and the MFP 100, and functions as a WLAN base station device. A communication apparatus having a WLAN communication function can communicate in WLAN infrastructure mode via the AP 111. Infrastructure mode may also be called “wireless infrastructure mode”. The AP 111 communicates wirelessly with a communication apparatus that has been permitted (authenticated) to connect to the AP 111 itself, and relays wireless communication between that communication apparatus and other communication apparatuses. The AP 111 can, for example, be connected to a wired communication network, and can relay communication between a communication apparatus connected to that wired communication network and another communication apparatus wirelessly connected to the AP 111.

The APs 112 and 113 have the same hardware configurations as the AP 111. The AP 111, the AP 112, and the AP 113 are APs that support multi-AP communication (described later), and that form a group (the multi-AP group 110) and operate in cooperation with each other.

The DHCP server 114 connects to the MFP 100 via the AP 111 and the network 120, and provides services to the MFP 100 by responding to requests from the MFP 100. Although FIG. 1 illustrates a configuration in which the DHCP server 114 is connected as a device separate from the AP 111, the AP 112, and the AP 113, the configuration may be such that the AP 111, the AP 112, and the AP 113 have DHCP server functionality.

The DNS server 115 is connected to the MFP 100, the mobile terminal device 101, and the like via the AP 111 and the network 120, and provides services for name resolution by responding to requests from the MFP 100, the mobile terminal device 101, and the like. Here, the network 120 may be the Internet, or may be a private network in a business, a mobile phone network, or the like.

### External Configuration of MFP

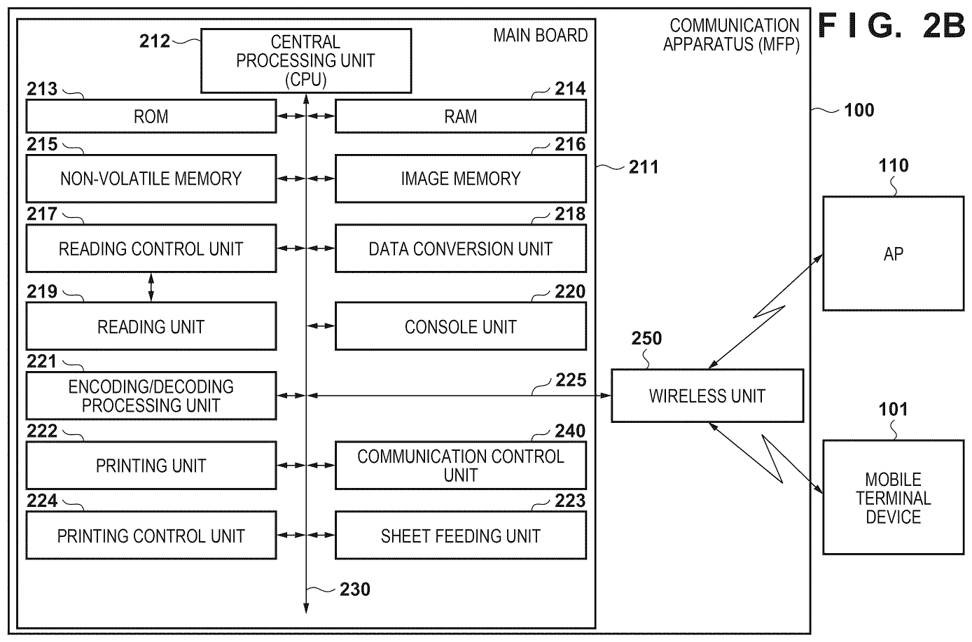

FIG. 2A illustrates an example of the external configuration of the MFP 100. The MFP 100 includes a document platform 201, a document cover 202, a printing paper insertion port 203, a printing paper discharge port 204, and a console unit 220, for example. The document platform 201 is a platform for placing a document to be read. The document cover 202 is a cover for securing a document placed on the document platform 201, and for ensuring that light from a light source that illuminates the document does not escape to the exterior when the document is being read (scanned). The printing paper insertion port 203 is an insertion port in which various sizes of sheets can be set. The printing paper discharge port 204 is a discharge port for discharging a sheet which has been printed onto. Paper set in the printing paper insertion port 203 is conveyed one sheet at a time to a printing unit, where the sheet is printed onto and then discharged from the printing paper discharge port 204. The console unit 220 is configured including a touchscreen, and is configured such that a user can launch various functions as an MFP, make various settings, and the like. The console unit 220 may also be configured including physical operation keys such as text input keys, a cursor key, an OK key, a cancel key, and the like, as well as LEDs, an LCD, and the like.

The MFP 100 has a WLAN wireless communication function and therefore is configured also including a wireless communication antenna 206 for that wireless communication, although the antenna 206 is not necessarily visible from the exterior. Like the mobile terminal device 101, the MFP 100 can communicate wirelessly over a WLAN.

### MFP Configuration

FIG. 2B illustrates an example of the configuration of the MFP 100. The MFP 100 is configured including a main board 211 that performs main control of the device itself, and a wireless unit 250, which is a single communication module that performs WLAN communication using at least one antenna. The MFP 100 may also be configured including a wired LAN unit for wired LAN communication, for example.

The main board 211 is configured including, for example, a CPU 212 (a central processing unit), a ROM 213, a RAM 214, a non-volatile memory 215, an image memory 216, a reading control unit 217, a data conversion unit 218, a reading unit 219, and an encoding/decoding processing unit 221. The main board 211 also includes, for example, a printing unit 222, a sheet feeding unit 223, a printing control unit 224, and a console unit 220. The function units in the main board 211 are connected to each other by a system bus 230 managed by the CPU 212. Additionally, the main board 211 and the wireless unit 250 are connected, for example, by a dedicated bus 225.

The CPU 212 is a system control unit including at least one processor, and controls the MFP 100 as a whole. The processing by the MFP 100 described below is implemented by the CPU 212 executing programs stored in the ROM 213, for example. Note that dedicated hardware for each process may be provided. The ROM 213 is a non-volatile memory that stores control programs executed by the CPU 212, embedded OS programs, and the like. In the present embodiment, the CPU 212 performs software control such as scheduling, task switching, and the like by loading each control program stored in the ROM 213 into the RAM 214 and executing the program under the management of an embedded OS, which is also stored in the ROM 213.

The RAM 214 is a volatile memory constituted by an SRAM or the like. The RAM 214 stores data such as program control variables, data such as setting values registered by the user and management data of the MFP 100, and the like. In addition, the RAM 214 can be used as various types of working buffers. The non-volatile memory 215 is constituted by a memory such as a flash memory, for example, and continues to store data even when the MFP 100 is turned off. The image memory 216 is constituted by a memory such as a DRAM. The image memory 216 stores image data received through the wireless unit 250, image data processed by the encoding/decoding processing unit 221, and the like. Note that the memory configuration of the MFP 100 is not limited to the configuration described above. The data conversion unit 218 analyzes data in various formats, converts image data into print data, and the like.

The reading control unit 217 controls the reading unit 219 (e.g., a contact-type image sensor (CIS)) to optically read (scan) a document placed on the document platform 201. The reading control unit 217 converts an image obtained by optically reading the document into electrical image data (an image signal) and outputs the image data. At this time, the reading control unit 217 may perform various types of image processing, such as binarization, half-tone processing, and the like before outputting the image data.

The console unit 220 includes a touchscreen that displays images based on display control by the CPU 212, and generates signals in response to accepting user operations made through the touchscreen, physical operation keys, and the like.

The encoding/decoding processing unit 221 performs encoding processing, decoding processing, scaling processing, and the like on image data handled by the MFP 100 (JPEG, PNG, and the like).

The sheet feeding unit 223 holds sheets for printing. The sheet feeding unit 223 can supply sheets set therein under the control of the printing control unit 224. The sheet feeding unit 223 may include a plurality of sheet feeding units to hold a plurality of types of sheets in a single apparatus, and from which sheet feeding unit sheets are fed can be controlled under the control of the printing control unit 224.

The printing control unit 224 applies various types of image processing, such as smoothing processing, print darkness correction processing, color correction, and the like, to the image data to be printed, and outputs the processed image data to the printing unit 222. The printing unit 222 is configured to be capable of executing ink jet printing processing, for example, so that ink supplied from an ink tank is ejected from a print head and an image is recorded on a recording medium such as paper. Note that the printing unit 222 may be configured to be capable of executing other types of printing processing, such as electrophotographic printing. The printing control unit 224 can also periodically read out information on the printing unit 222 and update status information and the like stored in the RAM 214, including the amount of ink remaining in the ink tank, the state of the print head, and the like.

The wireless unit 250 is a unit capable of providing a WLAN communication function, and is capable of providing functions similar to those of a wireless unit 401 of the mobile terminal device 101, for example. In other words, according to the WLAN standard, the wireless unit 250 converts data into packets and transmits the packets to other devices, and also restores packets from other external devices into the original data thereof and outputs the data to the CPU 212.

The wireless unit 250 is capable of performing communication as a station (“STA”, hereinafter) or an access point (AP) compliant with the IEEE 802.11 standard series. Specifically, communication compliant with the IEEE 802.11a/b/g/n/ac/ax/be/bn standards can be performed. The wireless unit 250 includes at least one processor and at least one memory in which programs are stored.

A communication control unit 240 is a unit that controls the communication functions of the MFP 100, and controls the wireless unit 250. The processing by the communication control unit 240 is realized by the CPU 212 executing a control program stored in the ROM 213. The communication control unit 240 and the wireless unit 250 are connected to each other by the system bus 230 and the dedicated bus 225, for example.

### MFP Console Unit

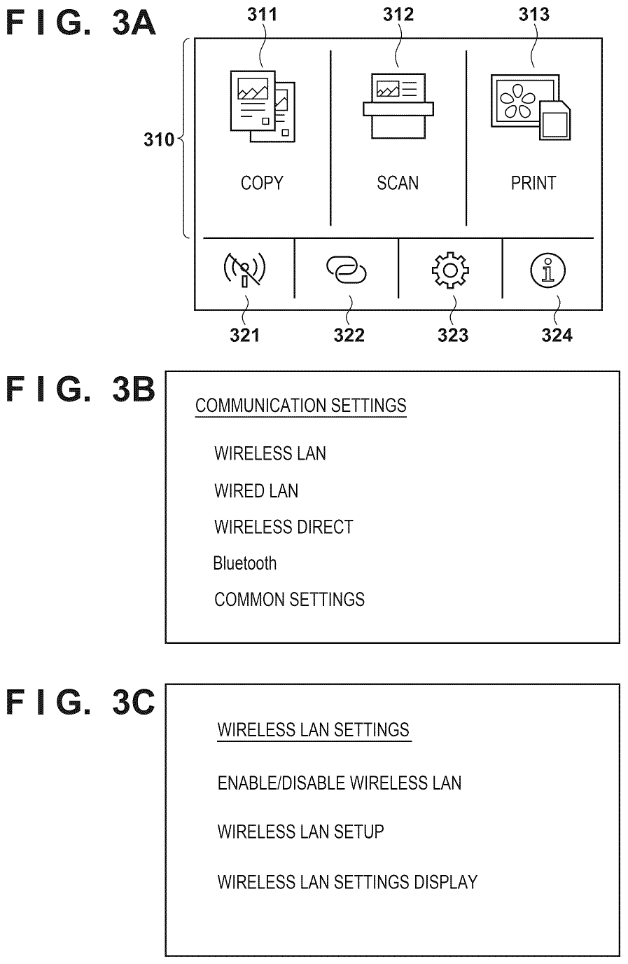

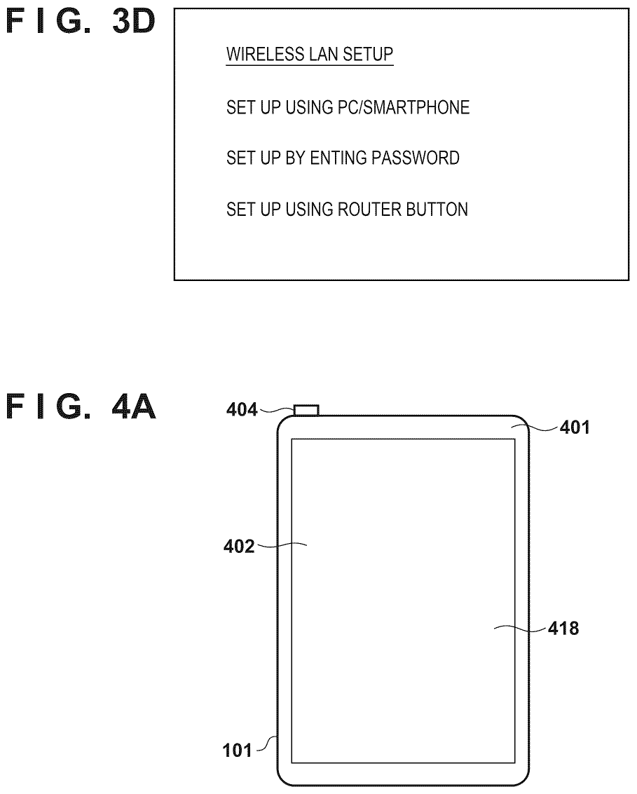

FIGS. 3A to 3D schematically illustrate examples of screens displayed on a display (a touchscreen) included in the console unit 220 of the MFP 100.

FIG. 3A illustrates an example of a home screen displayed when the MFP 100 is turned on and operations such as printing, scanning, or the like are not underway (an “idle state” or a “standby state”). A region 310 at the top of the home screen is a basic menu region, where menu items selected when instructing copying or scanning are displayed. In FIG. 3A, icons 311 to 313 corresponding to copying, scanning, and printing are listed as menu items (display items) in the basic menu in the region 310. When each menu item in the basic menu is selected, a corresponding detailed menu is displayed, and the MFP 100 can be caused to execute operations/functions (copying, scanning, or the like) corresponding to the selected menu item. A menu item different from the icons 311 to 313 can be displayed in the region 310 through an operation for displaying another page in the basic menu (an operation for sliding to the left or right in the region 310 or the like). For example, an icon corresponding to the cloud can be displayed. “Cloud” is a menu item related to a cloud function that uses Internet communication.

A network display region 320 is a region that displays icons indicating the state of the network, and in the example illustrated, three icons, namely icons 321, 322, and 323, are displayed. In the example illustrated, an icon indicating a status of connection with each AP (Coordinated AP) in a multi-AP group in the wireless infrastructure is displayed in the network display region 320. A more detailed screen indicating the communication status in the multi-AP group can be displayed by touching the network display region 320.

An icon 324 is an operation icon selected when changing the settings of the MFP 100 or performing maintenance.

An icon 325 is an icon indicating device information pertaining to the MFP 100, and error information based on error states in the main unit, methods for handling the errors, device-specific information, or the like can be confirmed through the icon 325.

FIG. 3B is an example of the screen display when a menu for communication settings is selected from a settings menu displayed when the icon 324 is touched in the home screen illustrated in FIG. 3A. “Wireless LAN”, “Wired LAN”, “Wireless Direct”, “Bluetooth”, and “Common” are displayed as menu items (options) in the communication settings menu screen. “Wireless LAN”, “Wired LAN”, and “Wireless Direct” are menu items for LAN settings, and settings such as wired connection settings, settings for enabling and disabling wireless infrastructure mode, settings for enabling and disabling a P2P mode such as WFD and software AP mode, and the like can be set using these items.

FIG. 3C is an example of the display of a menu screen for the wireless LAN settings, displayed when the “Wireless LAN” item has been selected in the screen illustrated in FIG. 3B. “Enable/Disable Wireless LAN”, “Wireless LAN Setup”, and “Wireless LAN Settings Display” are displayed as menu items (options) in the wireless LAN settings menu screen. The settings for enabling/disabling wireless infrastructure mode can be switched by selecting the “Enable/Disable Wireless LAN” item. When the “Wireless LAN Setup” item is selected, the wireless LAN setup menu in FIG. 3D is displayed. When “Display Wireless LAN Settings” is selected, a detailed screen displaying details such as the current wireless LAN settings and communication status (the wireless LAN settings display screen) is displayed.

FIG. 3D is an example of the display of a menu screen for wireless LAN setup, displayed when the “Wireless LAN Setup” item has been selected in the screen illustrated in FIG. 3C. “Set Up Using PC/Smartphone”, “Set Up by Entering Password”, and “Set Up Using Router Button” are displayed as menu items (options) in the wireless LAN setup menu screen. Wireless LAN setup such as setup using network setup mode (described later), setup by entering a password, setup using a pushbutton method, or the like can be performed using these items.

### External Configuration of Mobile Terminal Device

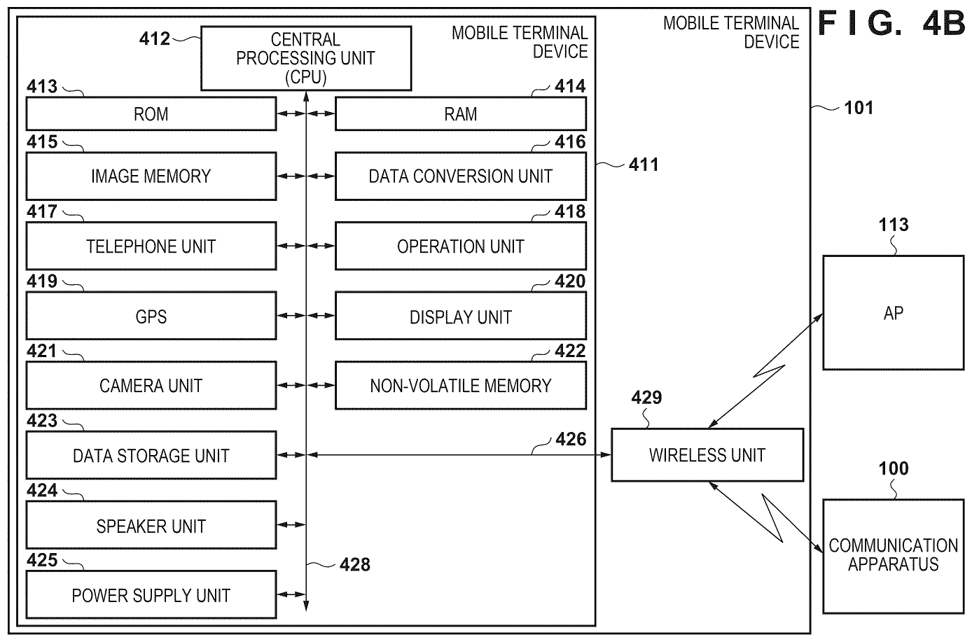

FIG. 4A is a diagram illustrating an example of the external configuration of the mobile terminal device 101. The present embodiment will describe a case where the mobile terminal device 101 is a typical smartphone, for example. Note that the mobile terminal device 101 is configured including a display unit 420, an operation unit 418, and a power key 404, for example. The display unit 420 is a display having an organic electroluminescence (EL)-based display mechanism or a Liquid Crystal Display (LCD)-based display mechanism, for example. Note that the display unit 420 may display information using a Light Emitting Diode (LED) or the like, for example. The mobile terminal device 101 may also have a function for outputting information by audio in addition to or instead of the display unit 420. The operation unit 418 is configured including physical keys such as keys, buttons, and the like, a touch panel, and the like for detecting user operations. Note that in this example, the information display in the display unit 420 and the acceptance of user operations by the operation unit 418 are performed using a common touchscreen, and thus the display unit 420 and the operation unit 418 are implemented as a single device. In this case, for example, button icons or a software keyboard are displayed using a display function of the display unit 420, and the user touching those locations is detected using an operation reception function of the operation unit 418. Note that the display unit 420 and the operation unit 418 may be separate, and the hardware for display and the hardware for accepting operations may be provided individually. The power key 404 is a physical key for accepting user operations for turning the mobile terminal device 101 on or off.

The mobile terminal device 101 includes the wireless unit 401, which provides WLAN communication functionality, but is not necessarily visible from the exterior. The wireless unit 401 is configured to be capable of data (packet) communication in a WLAN system compliant with the IEEE 802.11 standard series (IEEE 802.11a/b/g/n/ac/ax/be/bn), for example. However, the configuration is not limited thereto, and the wireless unit 401 may be capable of communication in a WLAN system compliant with another standard. This example assumes that the wireless unit 401 is capable of performing communication in both the 2.4 GHz and 5 GHz frequency bands. However, the wireless unit 401 is not limited thereto, and may be capable of performing communication in one or more frequency bands including the 2.4 GHz band, the 5 GHz band, and the 6 GHz band. The wireless unit 401 is also assumed to be capable of communication based on WFD, communication using software AP mode, communication using wireless infrastructure mode, and the like. Operations performed in these modes will be described later.

### Configuration of Mobile Terminal Device

FIG. 4B illustrates an example of the configuration of the mobile terminal device 101. The mobile terminal device 101 includes a main board 411 that performs main control of the device itself, and a wireless unit 429 that performs WLAN communication, for example. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym of “Central Processing Unit”, ROM is an acronym of “Read Only Memory”, RAM is an acronym of “Random Access Memory”, and GPS is an acronym of “Global Positioning System”. The mobile terminal device 101 also includes the display unit 420 and the operation unit 418. The function units in the main board 411 are connected to each other by a system bus 628 managed by the CPU 412. Additionally, the main board 411 and the wireless unit 429 (the wireless unit 401 mentioned earlier) are connected, for example, by a dedicated bus 426.

The CPU 412 is a system control unit including at least one processor, and controls the mobile terminal device 101 as a whole. The processing by the mobile terminal device 101 described below is implemented by the CPU 412 executing programs stored in the ROM 413, for example. Note that dedicated hardware for each process may be provided. The ROM 413 stores control programs executed by the CPU 412, embedded operating system (OS) programs, and the like. In the present embodiment, the CPU 412 performs software control such as scheduling, task switching, and the like by executing each control program stored in the ROM 413 under the management of an embedded OS, which is also stored in the ROM 413.

The RAM 414 is constituted by a Static RAM (SRAM) or the like. The RAM 414 stores data such as program control variables, data such as setting values registered by the user and management data of the mobile terminal device 101, and the like. In addition, the RAM 414 can be used as various types of working buffers. The image memory 415 is constituted by a memory such as a Dynamic RAM (DRAM) or the like. The image memory 415 temporarily stores image data received through the wireless unit 429, image data read out from the data storage unit 423, and the like for processing by the CPU 412. The non-volatile memory 422 is constituted by a memory such as a flash memory, for example, and continues to store data even when the mobile terminal device 101 is turned off. Note that the memory configuration of the mobile terminal device 101 is not limited to the configuration described above. For example, the image memory 415 and the RAM 414 may be implemented by the same memory, data may be backed up using the data storage unit 423, or the like. Additionally, although the present embodiment describes a DRAM as an example of the image memory 415, another storage medium such as a hard disk, a non-volatile memory, or the like may be used instead.

The data conversion unit 416 analyzes data in various formats, performs data conversion such as color conversion and image conversion, and the like. The telephone unit 417 controls a telephone line, and implements telephone communication by processing audio data input and output through the speaker unit 424. The GPS 419 receives radio waves transmitted from a satellite and obtains location information such as the current latitude, longitude, and the like of the mobile terminal device 101.

The camera unit 421 has a function for electronically recording and encoding an image input through a lens. The image data captured by the camera unit 421 is stored in the data storage unit 423. The speaker unit 424 performs control for implementing a function for inputting or outputting audio for the telephone function, other functions such as alarm notifications, and the like. The power supply unit 425 is a portable battery, for example, and controls the supply of power to the interior of the device. Power states include, for example, a “battery depleted state” in which there is no power remaining in the battery, a “power off state” in which the power key 404 has not been pressed, an “operating state” in which the battery is running normally, and a “power-saving state” in which the battery is operating but is in a power saving state.

The display unit 420 enables various types of input operations to be made, displays the operating state and status of the MFP 100, and the like under the control of the CPU 412. In response to user operations being accepted, the operation unit 418 performs control such as generating electrical signals corresponding to those operations and outputting the electrical signals to the CPU 412.

The mobile terminal device 101 performs wireless communication using the wireless unit 429, and performs data communication with other devices such as the MFP 100. The wireless unit 429 converts data into packets and transmits the packets to other devices. The wireless unit 429 also restores packets from other external devices into the original data and outputs the data to the CPU 412. The wireless unit 429 is a unit for implementing communication compliant with each WLAN standard. The wireless unit 429 can operate in at least two communication modes simultaneously, including wireless infrastructure mode and P2P (WLAN) mode. Note that the frequency bands used in these communication modes can be limited by the functions and performance of the hardware.

### Configuration of Access Point

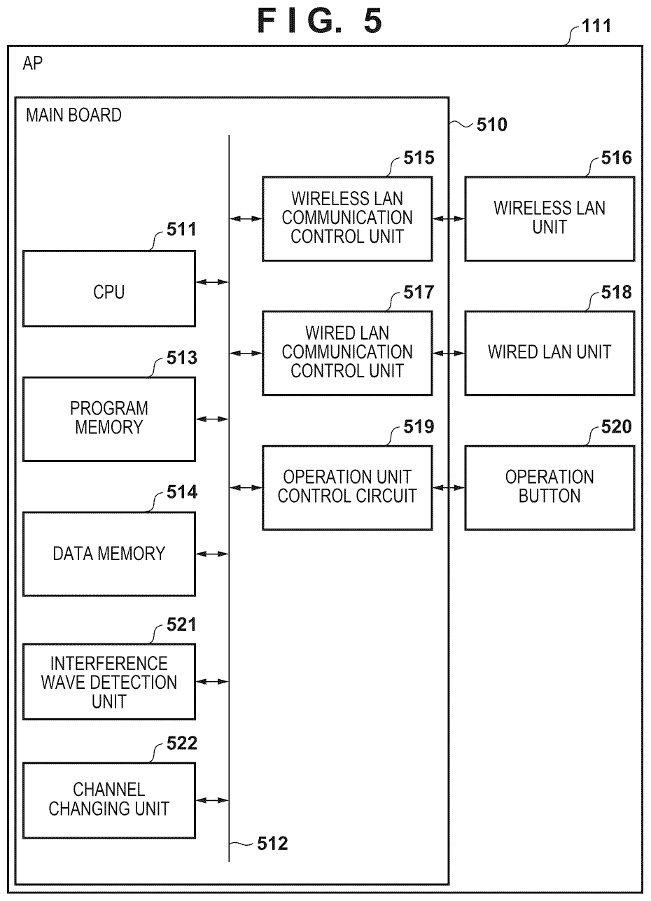

FIG. 5 is a block diagram illustrating the configuration of an AP 1 (111) having a wireless LAN access point function. A main board 510, which controls the AP 1 (111), is configured including a wireless LAN unit 516, a wired LAN unit 518, and an operation button 520.

A microprocessor-type CPU 511 disposed on the main board 510 operates in accordance with a control program stored in a ROM-type program memory 513 and data in a RAM-type data memory 514, which are connected to the CPU 511 by an internal bus 512. The CPU 511 performs communication with other communication terminal devices over a wireless LAN by controlling the wireless LAN unit 516 through a wireless LAN communication control unit 515. Specifically, the wireless LAN unit 516 is configured to be capable of data (packet) communication in a WLAN system compliant with the IEEE 802.11 standard series (IEEE 802.11a/b/g/n/ac/ax/be/bn), for example, as wireless LAN communication. The wireless LAN unit 516 is also capable of performing communication as an AP that supports multi-AP communication (described later). However, the configuration is not limited thereto, and the wireless LAN unit 516 may be capable of communication in a WLAN system compliant with another standard. This example assumes that the wireless LAN unit 516 is capable of performing communication in the 2.4 GHz, 5 GHz, and 6 GHz frequency bands. However, the wireless LAN unit 516 is not limited thereto, and may be capable of performing communication in one or more frequency bands including the 2.4 GHz band, the 5 GHz band, and the 6 GHz band.

The CPU 511 also performs communication with other communication terminal devices over a wired LAN by controlling the wired LAN unit 518 through a wired LAN communication control unit 517. The CPU 511 is capable of accepting operations made by a user manipulating the operation button 520, by controlling an operation unit control circuit 519. The CPU 511 includes at least one processor.

The AP 1 (111) also includes an interference wave detection unit 521 and a channel changing unit 522. The interference wave detection unit 521 performs interference wave detection processing when communicating wirelessly in a band in which Dynamic Frequency Selection (DFS) is implemented. When communicating wirelessly in a band in which DFS is implemented, the channel changing unit 522 performs processing for changing the channel used when interference waves are detected, when it is necessary to immediately change to a free channel, and the like.

Note that the APs 112 and 113 have the same configurations as the AP 111.

### P2P Communication Method

An overview of a P2P (WLAN) communication method for devices to wirelessly communicate directly with each other without traversing an external access point in WLAN communication will be given next. P2P (WLAN) communication can be implemented through a plurality of methods, e.g., the communication apparatus can support a plurality of modes for P2P (WLAN) communication and selectively execute P2P communication (WLAN) using one of the plurality of modes.

The following two modes are assumed as P2P modes.
Software AP Mode
Wi-Fi Direct (WFD) Mode

A communication apparatus capable of P2P communication can be configured to support at least one of these modes. However, even a communication apparatus capable of P2P communication does not have to support all of these modes, and may be configured to support only some.

In a communication apparatus having a WFD communication function (e.g., a mobile terminal device 104), an application for implementing the communication function (in some cases, a dedicated application) is called in response to a user operation being accepted through the operation unit of the device. The communication apparatus can then display a screen of a user interface (UI) provided by the application to prompt the user to perform an operation, and then perform WFD communication on the basis of the user operation accepted in response thereto.

### Software AP Mode

In software AP mode, the communication apparatus (e.g., the mobile terminal device 104) operates in the role of a client requesting various types of services. The other communication apparatus (e.g., the MFP 100) operates as a software AP capable of performing WLAN AP functions through software settings. Note that commands, parameters, and the like sent and received when establishing a wireless connection between the client and the software AP may be any specified by the Wi-Fi (registered trademark) standard, and will therefore not be described. The MFP 100 operating in software AP mode also determines a frequency band and a frequency channel as a parent station. Accordingly, the MFP 100 can select which frequency band to use from 5 GHz and 2.4 GHz, as well as which frequency channel to use in that frequency band.

### WFD Mode

The MFP 100 may be started so as to be fixed as the parent station for WFD mode (Autonomous Group Owner). In this case, GO Negotiation processing for determining the role is unnecessary. Furthermore, in this case, the MFP 100 also determines the frequency band and the frequency channel to be used as the parent station. Accordingly, the MFP 100 can select which frequency band to use from 5 GHz and 2.4 GHz, as well as which frequency channel to use in that frequency band.

### Wireless Infrastructure Mode

In wireless infrastructure mode, communication apparatuses that communicate with each other (e.g., the mobile terminal device 104 and the MFP 100) are connected to an external AP that manages the network (e.g., the AP 1 (111)), and the communication apparatuses communicate with each other through the AP. In other words, communication between the communication apparatuses is executed over a network constructed by an external AP. The mobile terminal device 104 and the MFP 100 both discover the AP 1 (111), and by transmitting a connection request and connecting to the AP 1 (111), those communication apparatuses can communicate in wireless infrastructure mode via the AP 1 (111). Note that a plurality of communication apparatuses may be connected to individual separate APs. In this case, the communication apparatuses can communicate by data being transferred among the APs. The commands, parameters, and the like sent and received during communication between the communication apparatuses via the access points may be any specified by the Wi-Fi standard, and will therefore not be described. In this case, the AP 1 (111) also determines the frequency band and the frequency channel. Accordingly, the AP 1 (111) can select which frequency band to use from 5 GHz, 2.4 GHz, and 6 GHz, as well as which frequency channel to use in that frequency band.

### Multi-AP Communication

In the IEEE 802.11be standard, Multi-Link communication is being standardized, in which, for example, a single access point (AP) establishes a plurality of links with a single station (STA) over a plurality of frequency channels, and communication is performed over those channels in parallel.

In addition, with the IEEE 802.11bn standard, which is the successor to the IEEE 802.11be standard, methods for improving usability using multi-AP communication are being considered.

A distributed multiple-input and multiple-output (MIMO) technique based on MIMO technology, in which a plurality of transmitting and receiving antennas are used in the same channel at the same time, can be given as an example. In distributed MIMO, in an environment where a plurality of APs and a plurality of STAs are present, groups are formed among the APs to share information about the communication state, the state of each AP, and the like, and data is sent from the plurality of APs to the STAs in parallel at the same timing. Joint transmission by the plurality of APs makes it possible to increase the number of spatial streams compared to when using a single AP, which is expected to improve throughput.

A technique in which a plurality of APs transmit data to an STA at different timings through time division, which improves the reception quality at the STA through the effects of time diversity and spatial diversity, can be given as another example.

A communication technique in which such a plurality of APs form a group and operate in cooperation with each other is called “multi-AP communication”, and the APs are classified into a single “Coordinator AP”, which manages all the APs, and “Coordinated APs”, which operate under the management of the Coordinator AP.

Hereinafter, in multi-AP communication, an AP that manages the other APs will be called a “Coordinator AP” or a “Sharing AP”. An AP that operates under the management of the Coordinator AP will be called a “Coordinated AP” or a “Shared AP”. The Coordinator AP and the Coordinated AP can exchange signals with each other. Each of the plurality of APs, including the APs 111 to 113, may be connected wirelessly to perform wireless LAN communication, or may be connected by wires to perform wired LAN communication. It is assumed that the APs 111 to 113 are capable of multi-AP communication in accordance with the IEEE 802.11 series standard, and support a configuration in which the plurality of APs operate in cooperation with each other to communicate with a single common STA.

Multi-AP communication methods include Co-OFDMA and Joint-TX. Co-OFDMA, or Coordinated-Orthogonal Frequency Division Multiple Access, separates usable frequency resources among a plurality of Basic Service Sets (BSSs). For example, the frequency resources used by the AP 112 and the MFP 100 (STA) and the frequency resources used by the AP 113 and the MFP 100 (STA) are separated so not to overlap with each other. This makes it possible to prevent the communication from interfering among the BSSs. When an STA is capable of transmitting and receiving data simultaneously in a plurality of frequency bands (a plurality of resource units within the same channel or spanning different channels, a plurality of channels, a plurality of bands among the 2.4 GHz, 5 GHz, and 6 GHz bands), a plurality of APs can operate in cooperation with each other to transmit and receive data to and from the same STA. The “data” is image data, audio data, document data, print data, or the like, which are content data. In this case, for example, transmitting a packet 1 of content A from the AP 112 to the MFP 100 (STA) and transmitting a packet 2 of the content A from the AP 113 to the MFP 100 (STA) can be performed in parallel.

In Joint-TX, or Joint-Transmission, the same signal is transmitted and received between a plurality of APs and a single STA. In this case, the control is performed such that a multiplexed wave (a superimposed wave; a composite wave), which is composited such that radio waves output from the plurality of APs are amplified through wave interference, is received by the STA. As a result, control is performed such that the STA receives a signal that is stronger than the signal from a single AP alone (an amplified signal). For example, the signals between the AP 112 and the MFP 100 (the STA) and between the AP 113 and the MFP 100 (the STA) are multiplexed such that the same signal is amplified at the position of the MFP 100 (the STA). For example, at the same timing, the packet 1 of the content A is transmitted from the AP 112 to the MFP 100 (STA), and the packet 1 of the content A is transmitted from the AP 113 to the MFP 100 (STA). At that time, the radio waves of the content A are transmitted such that the radio waves of the content A are multiplexed at the position of the MFP 100 (STA). This makes it possible to improve the reliability (connectivity) of communication between the STA and the AP, as well as the speed at which data is transmitted and received.

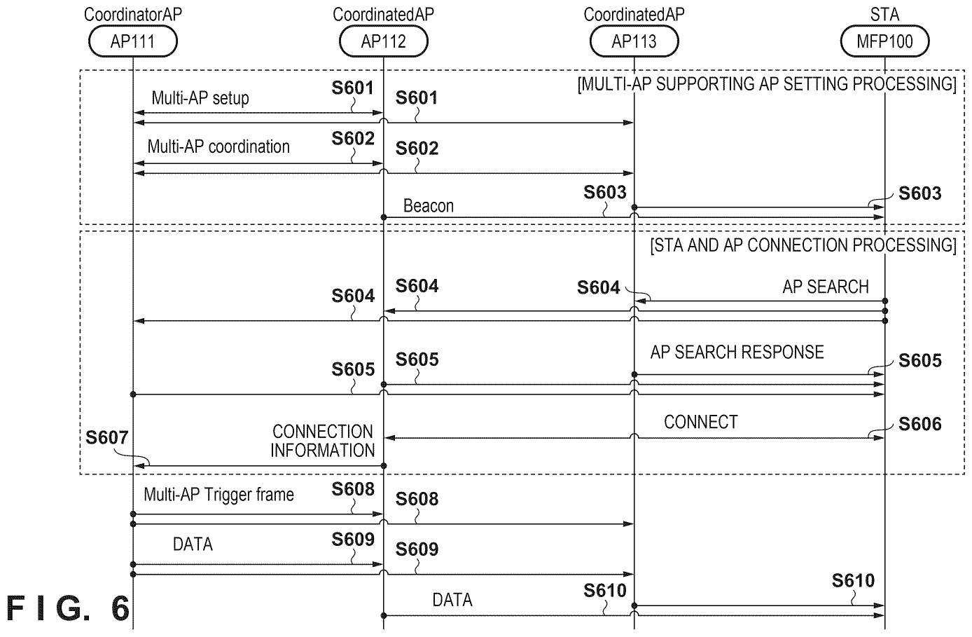

FIG. 6 is a sequence chart illustrating an example of processing in which the AP 111 operates as the Coordinator AP, and the AP 112 and the AP 113, which are Coordinated APs, operate in cooperation with each other to transmit and receive data to and from the MFP 100 (the STA). Processing executed by each device in this sequence is implemented by the CPU of each device reading out various programs stored in a memory provided in that device, such as a ROM or the like, into a RAM and executing those programs.

In step S601, the APs 111 to 113 perform multi-AP setup processing. In the multi-AP setup processing, capability information and parameters are exchanged among the APs, and a group for performing the multi-AP communication is formed.

In step S602, multi-AP coordination processing is performed among the APs 111 to 113. For example, the multi-AP communication method is determined, the roles of the APs (Coordinator AP or Coordinated AP) are determined, parameters and network information are exchanged among the APs, and the like. The multi-AP communication method and the roles of the APs are determined by exchanging and comparing parameters among the APs 111 to 113. At that time, the Coordinator AP (the AP 111) notifies the Coordinated APs (the AP 112 and the AP 113) of the network information to be used in common (the SSID to be used in common, the Basic Service Set color ID (BSSID) to be used in common, and the like). Note that the BSSID to be used in common is transmitted when using Joint-TX.

In step S603, the AP 112 and the AP 113 transmit a Beacon frame (information that the AP voluntarily transmits at regular intervals) in accordance with the network information transmitted in step S602. The Beacon frame includes information indicating that multi-AP communication can be performed to the connected STA, information indicating the multi-AP communication method, and the like. A multi-AP Information Element (IE) may be added and transmitted within the Beacon frame transmitted by the APs supporting multi-AP communication. The multi-AP IE includes at least one of the following items of information (one or more of the following items of information):
SSIDs used by a plurality of Coordinated APs belonging to the same multi-AP group (ESSIDs to be used in common, as transmitted in step S602)
a BSSID (the BSSID to be used in common for APs belonging to multi-AP group 110, transmitted in step S602 when using Joint-TX)
a BSS color value (identifier) for multi-AP communication
an operational wireless channel (a communication channel to be used in common when using Joint-TX. A communication channel and/or resource unit used by the source AP, when using Co-OFDMA. A communication channel and/or resource unit used by other APs in the multi-AP group 110 may be included when using Co-OFDMA.).
the multi-AP communication method (information that specifies whether the method is Co-OFDMA or Joint-TX)

Note that the storage method and the configuration of these items of information are not limited thereto, and similar information may be stored and transmitted in a similar format. Note that the multi-AP IE may have another name, such as “multi-AP element”. Additionally, the multi-AP IE may be included in a wireless frame such as the device search response (Probe Response) frame used in step S605, other Action frames, or the like.

In step S604, the MFP 100 (the STA) starts establishing a connection with an AP using wireless infrastructure mode. The MFP 100 (the STA) starts searching for the AP by transmitting a device search request (Probe Request) frame to determine whether the AP supports multi-AP communication.

In step S605, the MFP 100 (the STA) searches out and discovers the AP by receiving a device search response (Probe Response) frame, which is a response to the AP search, a Beacon frame, or the like transmitted from the AP.

In step S606, the MFP 100 (the STA) performs connection processing with at least one Coordinated AP on the basis of information included in the frame received in step S605. Here, it is assumed that the MFP 100 (the STA) transmits a connection request to the AP 112 and executes a connection attempt (the connection processing). The connection processing here includes processing such as Authentication and Association specified in IEEE 802.11. The MFP 100 (the STA) may add a multi-AP IE to a transmitted Association Request frame to request multi-AP communication. Having received the Association Request frame, the AP 112 transmits an Association Response frame as a response thereto. As a result, a wireless LAN connection is established between the MFP 100 (STA) and the AP 112.

In step S607, when a connection has been established with the MFP 100 (the STA), the AP 112 notifies the Coordinator AP (the AP 111) of information indicating that a connected state has been established with the MFP 100 (the STA), as well as the connection parameters pertaining to the connected MFP 100 (the STA). The connection parameters pertaining to the connected MFP 100 (the STA) include information used in the connection processing between the AP 112 and the MFP 100 or generated during the connection processing (a PMK cache, information necessary for roaming, authentication information, and the like), an identifier of the STA, and the like. When the AP 113 and the MFP 100 (the STA) are connected, the AP 113 similarly notifies the Coordinator AP (the AP 111) that a connected state has been established.

After step S607, the connection parameters pertaining to the MFP 100 (STA) transmitted in step S607 are transmitted from the AP 111 to the AP 113. The AP 113 may perform processing to establish a connection with the MFP 100 using the transmitted connection parameters pertaining to the MFP 100 (the STA). However, when using Joint-TX, data can also be transmitted from APs that have not established a connection. In other words, an AP that has not established a connection can also be a source of multiplexed radio waves. As such, the processing for establishing the connection between the AP 113 and the MFP 100 need not be performed.

In step S608, the Coordinator AP (the AP 111) determines transmission parameters (information necessary for determining each Coordinated AP, the transmission timing and transmission output for each antenna, and/or resource unit allocation information, and the like) on the basis of the connection parameters of the Coordinated AP that is connected to the MFP 100 (the STA) (the parameters received in step S607), and subsequently allocates transmission data. The information of the determined transmission parameters is transmitted to each Coordinated AP by a multi-AP Trigger frame. The APs 112 and 113 set their own transmission parameters (transmission timing, transmission output, and resource units to be used) on the basis of the transmitted information. Note that the multi-AP Trigger frame may have another name. The multi-AP Trigger frame may also be an extension of the Trigger frame defined in the IEEE 802.11ax/be standard.

In step S609, the Coordinator AP (the AP 111) transmits data to be transmitted to the MFP 100 (the STA) (e.g., content data such as image data, document data, print data, and the like) to the Coordinated APs.

In step S610, upon receiving the data to be transmitted from the Coordinator AP (the AP 111), the Coordinated APs (the APs 112 and 113) jointly transmit the data to be transmitted to the MFP 100. Upon receiving the data from the MFP 100 (the STA), the Coordinated APs (the AP 112 and the AP 113) transmit the received data to the Coordinator AP (the AP 111). Note that the order in which this data is transmitted and received is merely one example, and for example, the data from the STA may be received before the data is transmitted to the STA.

Note that the Coordinator AP may directly transmit and receive signals to and from the STA. For example, the AP 111 can operate as a Coordinator AP and a Coordinated AP. In this case, for example, the AP 111 may issue an instruction to the AP 112 or the AP 113 to cause the AP 112 or the AP 113 to exchange wireless frames with the STA while the AP 111 itself exchanges wireless frames with the STA. Note that the Coordinator AP can transmit the data to be transmitted to the Coordinated AP when the wireless frame is to be transmitted from the Coordinated AP. However, the configuration is not limited thereto, and the Coordinated AP may obtain data to be transmitted directly from the Internet, for example. The Coordinator AP may also receive data received by the Coordinated AP from the STA from a Coordinated AP, but the Coordinated AP may transfer the data received from the STA to a partner device of the STA without transferring the data to the Coordinator AP.

Note that any of the APs in the same network can operate as the Coordinator AP, and any one of the APs can be determined to operate as the Coordinator AP according to some criteria. Note that the Coordinator AP does not operate as an AP that transmits the Beacon frame, and may handle only the role of the Coordinator AP, such as sending instructions to each AP. Additionally, each AP may operate as a plurality of Coordinated APs by having a plurality of wireless LAN communication control units 515. The Coordinator AP may be implemented as a logical function, or a single physical AP may operate as a Coordinator AP while operating as one or more Coordinated APs.

It is assumed that an upper limit on the number of simultaneous connections that can be made by each communication device in the multi-AP communication is determined according to the limits of the hardware configurations of the wireless chips or antennas installed in the device, the setting for the number of connections that can be made by each device, and the like. Multi-AP communication may also be referred to as “multi-access point communication”. Although data is transmitted and received via a plurality of APs in multi-AP communication, the data may be data of a single item of content. A group of access points through which multi-access point communication is performed is called a “multi-access point group”. Accordingly, the Coordinator AP and the Coordinated AP are included in a single multi-access point group.

In addition, in Co-OFDMA, the STA periodically measures the connection status, radio wave strength information, and communication link speed with each of the APs connected simultaneously, and stores this information as a communication status.

### Display of Network Communication Status Using Icons

The display of icons indicating the wireless communication status of the MFP 100 will be described next with reference to the drawings.

FIG. 3A illustrates an example of a display in the MFP 100. The network display region 320 is constituted by icons 321, 322, and 323 indicating the state of an AP being communicated with through multi-AP communication. Although the present embodiment will describe an example in which three icons are displayed, it is conceivable to increase or reduce the number of icons displayed in models having different display screen constraints. For example, if the display screen is small, the number of icons may be reduced to 2 or fewer, whereas if the display screen is large, the number of icons may be increased to 4 or more. In either case, the effects of the present embodiment can be achieved when a plurality of icons can be displayed.

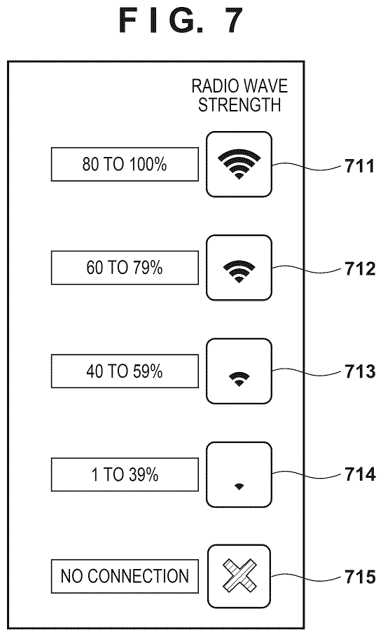

FIG. 7 illustrates an example of the icons shown in the regions for the icons 321, 322, and 323 in the network display region 320. The icon is displayed differently depending on differences in the radio wave strength with the AP during the connection, and in this example, an icon 711 is displayed when the radio wave strength is 80 to 100%; an icon 712, when the radio wave strength is 60 to 79%; an icon 713, when the radio wave strength is 40 to 59%; and an icon 714, when the radio wave strength is 1 to 39%. When there is no connection with an AP, an icon 715 is displayed as an icon in the network display region 320.

The MFP 100 performs communication by connecting to a plurality of APs through multi-AP communication. Accordingly, by displaying the icons illustrated in FIG. 7 in the form illustrated in FIG. 3A, the user can ascertain the status of the multi-AP communication from the displayed icon. More specifically, from the displayed icons, the user can intuitively ascertain the fact that multi-AP communication is being performed, as well as the number of APs in the multi-AP communication and the status of the communication with each AP.

This example describes the icons being different according to the measured radio wave strength of the wireless communication with the AP during the connection. However, the configuration is not limited thereto, and the icon may be switched to an icon displayed in accordance with the communication link speed, or to an icon displayed in accordance with a combination of the radio wave strength and the link speed. Even with such a configuration, the effect of the present embodiment, in which the user can ascertain the status of the multi-AP communication from the displayed icon, can be achieved. Furthermore, the effects of the present embodiment can be achieved by combining other factors pertaining to network communication, such as, for example, the communication method or encryption method used in the multi-AP communication, and displaying the icons in accordance with that combination. In this case, the user can also ascertain the status indicated by the icon, such as the communication method and the encryption method of the multi-AP communication.

### Detailed Display of Network Communication Status

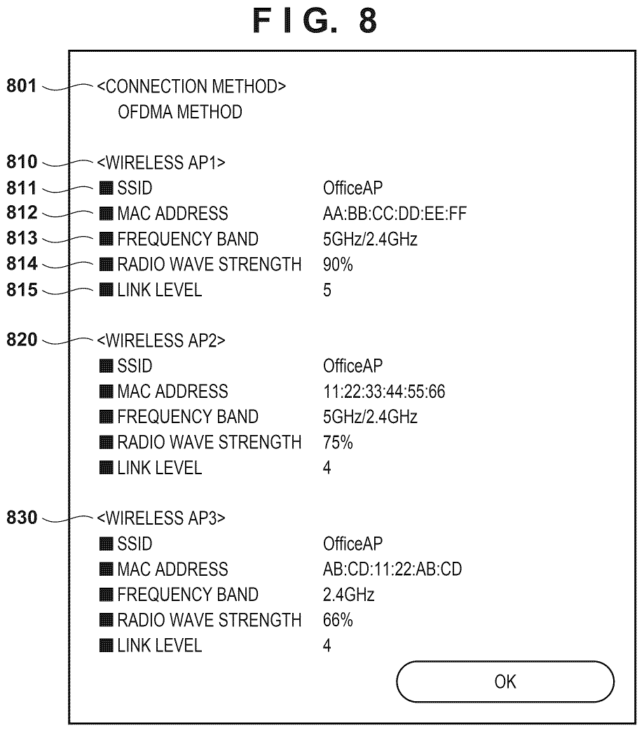

FIG. 8 is an example of the display of a detailed display screen of the network communication status when a predetermined operation has been performed, e.g., when the user has selected the network display region 320 on the display screen illustrated in FIG. 3A, which is displayed by the MFP 100. This screen is displayed when “Display Wireless LAN Settings” is selected in FIG. 3C.

The detailed display screen indicates a connection method 801 for multi-AP communication with a plurality of APs, and in this example, indicates that the APs are connected through OFDMA. Furthermore, names 810, 820, and 830 of the APs currently connected are displayed. In addition, SSID information 811, MAC address information 812, frequency band information 813, radio wave strength information 814, and link level information 815 for each of the APs currently connected are displayed on the detailed display screen. By viewing the detailed display screen, the user can ascertain the status of communication with each of the APs. Although this example describes a case where three APs are connected, the information is displayed for all of the APs that are connected in accordance with the communication state. Furthermore, the effects of the technique according to the present disclosure can be achieved by displaying other individual information pertaining to AP communication, such as an encrypted communication method, a friendly name, and the like in addition to the information pertaining to the AP presented here.

### Icon Display Processing

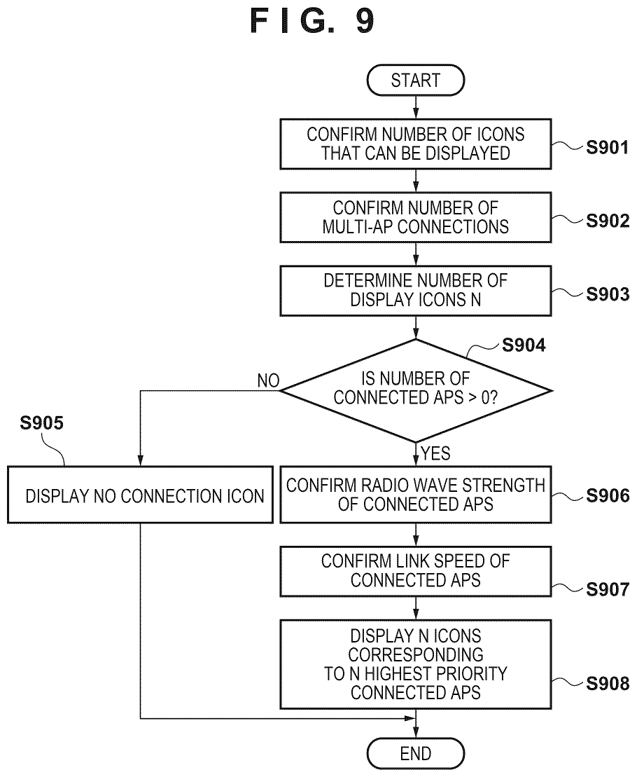

FIG. 9 is a flowchart illustrating an example of icon display processing performed with respect to an AP currently connected, for the network display region 320 displayed by the MFP 100. The processing illustrated in FIG. 9 is processing started when the display screen illustrated in FIG. 3A (the home screen) is displayed, and is repeated periodically while the home screen is displayed. Note that the processing in FIG. 9 focuses only on the network display region 320 of the home screen, and other regions may already be displayed (or updated) before the network display region 320, for example. Conversely, the display may be performed (or updated) after the display of the network display region 320. The processing illustrated in FIG. 9 is realized by the CPU 212 of the MFP 100 loading programs stored in the non-volatile memory 215, for example, into the RAM 214, and executing those programs. Note that the MFP 100 may be referred to as a “communication apparatus”, focusing on the communication function thereof.

In step S901, the CPU 212 obtains a predetermined number of icons that can be displayed in the network display region 320 (a number of icons that can be displayed) in accordance with the size of the console unit 220 of the MFP 100, the layout of the display screen, and the like, after which the sequence moves to step S902. The number of icons displayed is no greater than the predetermined number of icons that can be displayed. The number of icons that can be displayed in the network display region 320 is assumed to be a number based on the screen to be displayed, the state to be displayed, and the like. The number of icons that can be displayed is determined in advance for each MFP model, for example, and may be saved in the ROM 213 or the like. For example, when the screen illustrated in FIG. 3A is displayed, information indicating that the number of icons that can be displayed in the network display region 320 is 3 is obtained from the ROM 213. The number may be different for screens aside from that illustrated in FIG. 3A. For example, icons may be displayed in a region for a status bar in which a plurality of other types of icons are displayed, such as the remaining battery power, various notification icons, icons indicating other communication states, and the like. In such a case, the number that can be displayed in the network display region 320, which indicates the wireless LAN communication status, may be a number lower than 3, such as 2 or 1. However, to indicate that multi-AP communication is underway, it is desirable for the number that can be displayed to be greater than 1, and that number is therefore 3 in the present embodiment. The various notification icons are, for example, at least one of a notification icon indicating that a message has been received, an icon indicating that an update is available, an icon indicating that an error has occurred, an icon indicating the state of sound output, such as volume settings or muting, and the like. The icon indicating another communication state is at least one of an icon indicating the state of Bluetooth and an icon indicating the communication state of a mobile phone line, for example.

Basically, the number of icons that can be displayed in the network display region 320 is set so that the number of icons that can be displayed is higher when the area of the display region for displaying the icons is large than when that area is small. In addition, the number of icons that can be displayed in the network display region 320 is set to be lower when the number of other types of icons or other notifications displayed on the same screen is high than when that number is low.

In step S902, the CPU 212 obtains the number of APs currently connected to the MFP 100 through multi-AP communication (a number of connected APs). The number of connected APs is a number that is no greater than the number of APs that can be connected simultaneously through multi-AP communication, and is the number of Coordinated APs (also called “Coordinated Access Points”) for which a connection is currently established (i.e., which are connected). If an AP is connected but multi-AP communication is not being performed, the number of connected APs obtained here is 1.

In step S903, the CPU 212 determines an icon display number N, which is the number of icons to be displayed in the network display region 320. The icon display number N is determined to be the lower of the number of icons that can be displayed, obtained in step S901, and the number of connected APs, obtained in step S902.

In step S904, the CPU 212 determines whether the number of APs currently connected, obtained in step S902, is greater than 0. The sequence moves to step S906 if the number of APs currently connected is determined to be greater than 0, and to step S905 if not (i.e., if no AP is connected).

In step S905, the CPU 212 displays the icon 715, which is a display made when no AP is currently connected, in the network display region 320, after which the sequence ends.

In step S906, the CPU 212 confirms (obtains) the radio wave strength for all of the APs currently connected. The radio wave strength may be obtained by, for example, each of the APs in the multi-AP group 110 measuring the radio wave strength of a signal received from the MFP 100 and transmitting the radio wave strength to the MFP 100, or by the MFP 100 measuring the radio wave strength of each of signals received from the APs in the multi-AP group 110. However, it is conceivable that the amount of data received from an AP by the MFP 100 may be greater than the amount of data transmitted to the AP, and thus the radio wave strength on the downlink, i.e., of the signal received from the AP, may be used preferentially. Note that the radio wave strength may be measured at any time during the obtainment, or the newest value among the values measured periodically may be used. In either case, the newest value among those values is assumed to be obtained.

In step S907, the CPU 212 confirms (obtains) the communication link speed for all of the APs currently connected. As with the radio wave strength, the link speed measured by either the AP or the MFP 100 may be used, but the link speed on the downlink may be used preferentially. Note that the link speed may be measured at any time during the obtainment, or the newest value among the values measured periodically may be used. In either case, the newest value among those values is assumed to be obtained.

In step S908, the CPU 212 determines a display priority on the basis of a predetermined condition. Here, the display priority is calculated on the basis of the information of the APs currently connected, obtained in steps S906 and S907, as the predetermined condition. The CPU 212 further selects N of the currently-connected APs (the values determined in step S903) in order from the highest display priority, and displays the N icons corresponding to the N APs in the network display region 320. At this time, the icons are displayed side-by-side in order from the highest display priority. For example, the N icons displayed are displayed side-by-side in a layout in which the icon of the AP having a higher display priority is located on the left and the icon of the AP having a lower display priority is located on the right. A method for determining the display priority will be described later. Additionally, each of the N icons is displayed in any of the forms illustrated in FIG. 7, on the basis of the radio wave strength of the corresponding AP. Here, if the number of currently-connected APs obtained in step S902 is greater than N, icons corresponding to some (i.e., N) of the currently-connected APs, rather than all of the currently-connected APs, are displayed. In other words, the radio wave strength display using an icon is not performed for some of the currently-connected APs. In this manner, a limited display space can be utilized effectively by using icons to display the radio wave strengths of only some of the currently-connected APs, with the rest omitted, rather than for all of the currently-connected APs.

For example, a case where the number of icons that can be displayed, obtained in step S901, is 3, and the number of APs currently connected, obtained in step S902, is 5, will be described. In this case, the icon display number N is 3. Accordingly, three radio wave strength icons corresponding to the APs having the first, second, and third display priorities are displayed in order from the highest display priority, as described with reference to FIG. 3A. Doing so makes it possible for the user to know that multi-AP connections are present and the radio wave strength for each of the plurality of APs that are connected, and the user can therefore more accurately ascertain the connection statuses of the APs. For example, if the radio wave conditions of two of the three icons displayed are indicated as being good, the user can recognize that the positive effects of multi-AP communication can be achieved, and that the radio wave conditions are better than in a situation where only one AP is connected.

On the other hand, the remaining two APs having a display priority of fourth or lower have a low priority, and the information thereof is therefore of little importance to the user. For example, if the radio wave conditions of the three APs having the highest display priorities are good, the radio wave conditions are good enough for the MFP 100, and the radio wave conditions of the two APs having the lower display priorities will have little effect regardless of whether those radio wave conditions are good or poor. Meanwhile, for example, if the radio wave conditions of the three APs having the highest display priorities are poor, the radio wave conditions of the two APs having the lower display priorities will likely be even worse. The radio wave conditions will therefore be poor for the MFP 100 regardless of whether the radio wave conditions of the two APs having the lowest display priorities are displayed. In this manner, the radio wave strengths for the APs having low display priorities are of low importance to the user, and displaying icons related thereto will therefore waste the display space. However, with the present embodiment, radio wave strength icons are not displayed for APs having low display priorities (of APs exceeding the number that can be displayed), which makes it possible to avoid wasting display space.

Through the processing described thus far, information pertaining to the plurality of APs currently connected through multi-AP communication can be presented to the user through icon displays made according to the display capabilities of the MFP 100.

### Determining Icons According to Communication Environment

Next, an example of displaying icons according to the communication environment and communication status pertaining to multi-AP communication by the MFP 100 will be described with reference to the drawings.

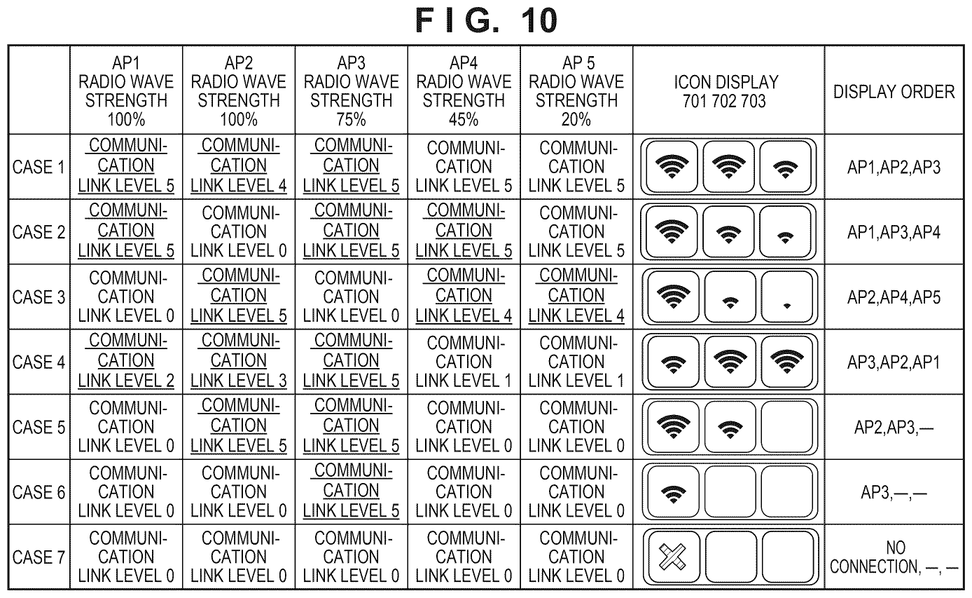

FIG. 10 illustrates an example of an icon display when the communication link level for each AP corresponds to cases 1 to 7, in a state where AP 1 and AP 2 having a radio wave strength of 100%, AP 3 having a radio wave strength of 75%, AP 4 having a radio wave strength of 45%, and AP 5 having a radio wave strength of 20% are present in the vicinity of the MFP 100. Examples of icons 321, 322, and 323 displayed in the network display region 320 are indicated in an icon display field. Here, the communication link level is a numerical value expressing the level of the communication speed according to the communication status in a simplified manner, and is expressed as levels 5 to 0. An AP having a level of 0 indicates that the AP is not connected to the MFP 100. The APs in the columns that are underlined in each case in the table in FIG. 10 are APs for which icons are to be displayed on the basis of the display priority. Icons are not displayed for APs in columns which are not underlined.

The link level indicates the communication speed between the AP and the MFP 100, categorized into one of six levels, from 0 to 5, which correspond to a range between the maximum speed specified by the wireless communication standard and a speed of 0. The link may be an uplink, a downlink, or an average thereof. For the radio wave strength, the ratio of the radio wave strength of the received signal to a maximum power is indicated as a percentage. The radio wave strength may also be measured by the MFP 100, or may be measured by the AP. However, the methods for evaluating the link speed and the radio wave strength are the same for all the APs.

The present embodiment describes an example of displaying icons when a value obtained by multiplying the numerical value of the radio wave strength of each AP by the numerical value of the communication link level is used as the display priority value. These descriptions are simplified, however, and the same effects as those described in the present embodiment can be achieved even when the display priority values are determined taking into account other information pertaining to communication with the AP, weights based on those items of information, and the like.

In case 1, the communication link levels for the AP 1 to the AP 5 are 5, 4, 5, 5, and 5, and the display priority values obtained by multiplying the radio wave strengths of 100, 100, 75, 45, and 20 are 500, 400, 375, 225, and 100, respectively. The display priority value indicates the priority of the icon display. In this case, the AP 1, which has the highest display priority value of 500, the AP 2, which has the next-highest display priority value of 400, and the AP 3, which has the next-highest display priority value of 375, are selected, and the icons corresponding to those APs are displayed as the icons 321, 322, and 323, respectively, in the network display region 320.

In case 2, the communication link levels for the AP 1 to the AP 5 are 5, 0, 5, 5, and 5, and the display priority values are therefore calculated as 500, 0, 375, 225, and 100, respectively. In this case, a selection is made to display the AP 1, the AP 3, and the AP 4 in order from the highest value, and the icons corresponding thereto are displayed as icons in the network display region 320.

Similarly, in case 3, the communication link levels for the AP 1 to the AP 5 are 0, 5, 0, 4, and 4, and the icons for the AP 2, the AP 4, and the AP 5 are displayed in the network display region 320 in order from the highest priority, according to the calculated values.

In case 4, the communication link levels for the AP 1 to the AP 5 are 2, 3, 5, 1, and 1, the calculated values are 200, 300, 375, 45, and 20, and the icons for the AP 3, the AP 2, and the AP 1 are therefore displayed as icons 321, 322, and 323 in the network display region.

In case 5, only the AP 2 and AP 3 are currently connected to the MFP 100, and thus icons for the AP 2 and AP 3 are displayed as the icons 321 and 322, with the icon 323 remaining blank. Displaying the icon 323 blank indicates that more APs can be connected to the MFP 100.

In case 6, only the AP 3 is currently connected, and the icon of the AP 3 is displayed as the icon 321, with the icons 322 and 323 remaining blank.

In case 7, no AP is currently connected to the MFP 100, and the icon 715 indicating that there is no connection is displayed for the icon 321, to indicate that no AP is currently connected.

Note that the method for determining the display priorities is not limited to the example described above. The display priority may simply correspond to the radio wave strength of each AP. The display priority may also simply correspond to the communication link level of each AP. Alternatively, a different indicator may be used as the display priority.

The present embodiment describes a case where the number of APs that can be connected in multi-AP communication by the MFP 100 is at least 3, and the number of icons that can be displayed is 3. If, for example, the number of APs that can be connected is lower than the number of icons that can be displayed, e.g., 2, the AP connection capacity of the MFP 100 can be indicated by setting the number of icons that can be displayed to the same number as the number of APs that can be connected, i.e., 2.

As described thus far, displaying, in the console unit 220 of the MFP 100, AP connection information of the APs currently connected in the multi-AP communication as icons in accordance with the display priorities makes it possible for the user to easily ascertain the connection status of the multi-AP communication. Using index values pertaining to the communication status, such as radio wave strength and link speed, as the display priorities, makes it possible to preferentially display an AP which is dominant in terms of the communication status in multi-AP communication during the connection. This makes it possible for the user to intuitively ascertain that the MFP 100 is performing multi-AP communication, as well as the number of APs connected and the status of connection with each AP in such a case.

The above-described various types of control performed by the CPUs of the respective devices may be performed by a single piece of hardware, or the control of the apparatus as a whole may be performed by dividing the processing up among multiple pieces of hardware (e.g., multiple processors or circuits).

Although the foregoing has described the present disclosure in detail on the basis of preferred embodiments thereof, the present disclosure is not intended to be limited to the specific embodiments, and all variations that do not depart from the essential spirit of the present disclosure are intended to be included in the scope of the present disclosure. Furthermore, the above-described embodiments are merely embodiments of the present disclosure, and different embodiments can be combined as appropriate.

Although the foregoing embodiment describes a case where the present disclosure is applied to an MFP as an example, the present disclosure is not limited to this example, and can be applied in any wireless device capable of multi-AP communication. In other words, the present disclosure can be applied in personal computers, PDAs, tablet terminals, mobile telephone terminals such as smartphones, music players, game consoles, e-book readers, smart watches, various measurement devices (sensor devices) such as thermometers and hygrometers, and the like. The present disclosure can also be applied in digital cameras (including still cameras, video cameras, network cameras, and security cameras), printers, scanners, and drones. The present disclosure can also be applied in video output devices, audio output devices (e.g., smart speakers), streaming media players, wireless LAN client devices (adapters) to which USB terminals, LAN cable terminals, or the like can be connected, and the like. Video output devices include, for example, a device such as a set-top box, which obtains (downloads) a moving image or still image on the Internet, specified by a URL provided by a communication apparatus, and outputs the moving image or still image to a display device connected through a video output terminal such as an HDMI (registered trademark) terminal. Through this, streaming playback, a mirrored display (a display in which content displayed in a communication apparatus is also displayed on a display device), or the like is implemented in a display device. The video output device also includes a media player such as a television, a hard disk recorder, a Blu-ray recorder, a DVD recorder, or the like, as well as a head-mounted display, a projector, a television, a display device (monitor), a signage device, or the like. The present disclosure can also be applied in a device capable of connecting through Wi-Fi, or what is known as a “smart home appliance”, such as an air conditioner, a refrigerator, a washing machine, a vacuum cleaner, an oven, a microwave oven, a lighting fixture, a heating appliance, a cooling appliance, or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-233117, filed Dec. 27, 2024 which is hereby incorporated by reference herein in its entirety.

What is claimed is:

1. A communication apparatus comprising:
at least one memory and at least one processor which function as:
a connection unit configured to connect to a plurality of access points;
a communication unit configured to transmit and receive data via the plurality of access points; and
a display control unit configured to perform control such that a status of connection with each of a first number of access points included in the plurality of access points is displayed in a display unit using the first number of icons, the first number being two or more.

2. The communication apparatus according to claim 1,
wherein the first number is lower than a total number of the plurality of access points that are currently connected.

3. The communication apparatus according to claim 1,
wherein the display control unit determines the first number of access points from the plurality of access points based on a predetermined condition.

4. The communication apparatus according to claim 3,
wherein the predetermined condition includes a radio wave strength measured for the plurality of access points that are currently connected.

5. The communication apparatus according to claim 3,
wherein the predetermined condition includes a link speed measured for the plurality of access points that are currently connected.

6. The communication apparatus according to claim 3,
wherein the predetermined condition includes a value calculated based on a radio wave strength and a link speed measured for the plurality of access points that are currently connected.

7. The communication apparatus according to claim 1,
wherein the display control unit changes the icons according to the connection statuses of the plurality of access points that are currently connected.

8. The communication apparatus according to claim 1,
wherein in a case where no access point is currently connected, the display control unit performs control to display an icon indicating that no access point is currently connected.

9. The communication apparatus according to claim 1,
wherein the data is data of a single item of content.

10. The communication apparatus according to claim 1,
wherein the display unit includes a display region in which a predetermined number of icons are displayable, and
the first number is the predetermined number or less.

11. The communication apparatus according to claim 1,
wherein the display control unit is further configured to perform control such that the status of connection with each of all of the plurality of access points that are currently connected is displayed in the display unit in response to a predetermined operation.

12. The communication apparatus according to claim 1,
wherein the first number of access points are a plurality of coordinated access points included in a single multi-access point group.

13. A non-transitory computer-readable storage medium having stored therein a program that, when loaded and executed by a computer, causes the computer to execute processing, the processing comprising:
connecting to a plurality of access points;
transmitting and receiving data via the plurality of access points; and
performing control such that a status of connection with each of a first number of access points included in the plurality of access points is displayed in a display unit using the first number of icons, the first number being two or more.

14. A control method executed by a communication apparatus capable of connecting to a plurality of access points, the control method comprising:
transmitting and receiving data via the plurality of access points; and
performing control such that a status of connection with each of a first number of access points included in the plurality of access points is displayed in a display unit using the first number of icons, the first number being two or more.
